(19) United States
(12) Patent Application Publication
(10) Pub. No.: US 2017/0350767 A1
(43) Pub. Date: Dec. 7, 2017

(54) THERMOCOUPLE SYSTEM HAVING A TERMINAL END REGION

(71) Applicant: Siemens Aktiengesellschaft, Munich (DE)

(72) Inventors: Gilbert Braun, Herzogenrath (DE); Andreas Böttcher, Mettmann (DE); Olga Deiss, Düsseldorf (DE); Thomas Grieb, Krefeld (DE); Ljiljana Hanf, Mülheim an der Ruhr (DE); Jens Kleinfeld, Mülheim an der Ruhr (DE); Tobias Krieger, Oberhausen (DE); Fabian Sander, Mülheim (DE)

(73) Assignee: Siemens Aktiengesellschaft, Munich (DE)

(21) Appl. No.: 15/538,817

(22) PCT Filed: Dec. 30, 2015
(86) PCT No.: PCT/EP2015/081448

§ 371 Date: Jun. 22, 2017

(30) Foreign Application Priority Data
Jan. 8, 2015 (DE) 10 2015 200 104.0

(51) Int. Cl. G01K 7/08; G01K 1/14; G01K 13/02; G01K 7/02; G01K 1/08

(52) U.S. Cl. CPC G01K 7/08; G01K 1/14; G01K 13/028; G01K 1/08; G01K 7/023

(57) ABSTRACT

A thermocouple system, has a metal feedthrough having a cylindrical portion having an axis of symmetry and a terminal end region arranged thereon, which completely closes the cylindrical portion, and which has at least two passageways, the opening cross-section of which is smaller than the cross-sectional surface vertical to the axis of symmetry through the cylindrical portion. Through one passageway, a thermocouple is guided, and in the region of the passageway, the thermocouple is connected to the end region in a fluid-tight manner by way of a seal.

### CROSS REFERENCE TO RELATED APPLICATIONS

This application is the US National Stage of International Application No. PCT/EP2015/081448 filed Dec 30, 2015, and claims the benefit thereof. The International Application claims the benefit of German Application No. DE 102015200104.0 filed Jan 8, 2015. All of the applications are incorporated by reference herein in their entirety.

### FIELD OF INVENTION

The present invention relates to a thermocouple system for positioning thermocouples in a working machine such as a gas turbine. In such machines, temperature measurements, on account of the level of the occurring temperatures, are typically carried out with the aid of thermocouples which are guided through the outer casing of the working machine into an inner operating region. In order to protect the outer casing of the working machine against escape of for example working medium, the leadthroughs have to be suitably sealed. For such sealing purposes, according to the internal prior art which is known to the applicant, provision is made in the first instance for special cement by means of which the thermocouple is attached for example directly or indirectly to the outer casing of the working machine.

### BACKGROUND OF INVENTION

If a thermocouple fastened in such a way is faulty, however, and has to be exchanged on account of this, it is necessary in most cases to remove the special cement in a costly mechanical manner so that the thermocouple can be removed from the outer casing of the working machine again. In particular, with the provision of a multiplicity of thermocouples, which have to be guided through the outer casing of the working machine, then the exchangeability and maintainability of these components can be liable to severe limitations. Moreover, the outer casing itself and therefore the entire working machine can also suffer damage. Particularly in the case of working machines which are very cost intensive during operation, such as gas turbines, this increased maintenance cost also means an extended downtime and therefore higher economical losses for the operator.

In order to at least partially address these problems, a changeover was made to guiding the necessary thermocouples through thin tubes, the thickness of which can interact with fastening systems, such as those of the Swagelok Company, which are known from the prior art. The thermocouples are cast in turn into these thin tubes with special cement (for example from Sauereisen), wherein the entirety of tubes, special cement and thermocouple is clamped into a suitable recess in the casing outer side of the working machine. In the case of a gas turbine, the thermocouples are fastened for example in the region of the burners by clamping on the casing outer flange.

With this, however, additionally known disadvantages, such as a comparatively long hardening time (up to 24 hours) of the special cement and also a necessary destruction of the leadthrough or of the tubes when exchanging the thermocouple, have to be accepted.

### SUMMARY OF INVENTION

In this respect, it is shown to be technically desirable to propose a technical solution which can avoid the above disadvantages which are known from the prior art. Especially to be proposed is a thermocouple system which enables shorter maintenance times when exchanging individual thermocouples and which at the same time can be fastened in the region of the outer casing of a working machine using previous fastening systems which are known from the prior art. The fastening, moreover, has to be sufficiently pressure-tight and fluid-tight.

These objects upon which the invention is based are achieved by means of a thermocouple system as claimed and also by means of a gas turbine as claimed.

The objects upon which the invention is based are especially achieved by means of a thermocouple system comprising a metal leadthrough with a cylindrical section with a symmetry axis and also a terminal end region arranged thereon which completely closes off the cylindrical section and has at least two passages, the opening cross section of which is smaller than the cross-sectional area perpendicularly to the symmetry axis through the cylindrical section, wherein a thermocouple is guided through a passage and in the region of the passage the thermocouple is connected in a fluid-tight manner to the terminal region by means of a seal.

The objects upon which the invention is based are also achieved by means of a gas turbine having at least one thermocouple system, as described above and also below, wherein the thermocouple system is integrated into the outer casing of the gas turbine. In this case, the location of the attachment is advantageously that of the casing flange in the region of a burner of the gas turbine.

At this point, reference is to be made to the fact that the symmetry axis according to the invention is the rotational symmetry axis of the cylindrical section. The opening cross section of the at least two passages is also to be matched to the outer wall of the terminal end region and in most cases has a round or oval opening cross section.

The sealing of the at least one thermocouple in the region of the passage of the metal leadthrough can in turn be carried out with a special cement, as is known from the prior art. It is advantageously provided, however, that a solder forms the seal. With this, as deduced by the person skilled in the art, attention is to be paid to the fact that the solder is able to withstand the temperatures which occur on the working machine, but at the same time has adequate pressure-tightness and fluid-tightness. Hard solders, which have a melting point of more than 300° C., are suitable for such sealing.

The complete closure of the cylindrical section by the terminal end region naturally excludes those passages which for example are not provided with a thermocouple and a corresponding seal.

When the respective thermocouple system is in use, attention is to be paid, however, to the fact that such passages which are not provided with a thermocouple and seal are also sufficiently sealed. In this case also, a suitable seal by means of special cement or solder is for example suitable but without a thermocouple being guided through the passage. Whereas, therefore, the thermocouple system according to the invention can be all means still have free unsealed passages, it is necessary that the thermocouple system, providing it is used specifically in a working machine, needs to have all passages adequately sealed.

According to the invention, it is provided to provide a metal leadthrough which in addition to a cylindrical section has a suitably formed terminal end region in which are located at least two passages through which a thermocouple can be guided in each case. The connection between thermocouple and terminal end region is effected by means of a suitable seal, as explained above and also below. In this way, it is possible to guide at least two thermocouples through an associated passage of the terminal end region in each case, wherein the metal leadthrough itself can in turn be fastened to the outer casing of a working machine via the cylindrical section using suitable fastening systems, as are known for example from the prior art, for example a Swagelok system.

If it is now necessary, perhaps due to damage of a thermocouple, to remove this thermocouple, it is no longer necessary, as according to the prior art, to remove the entire metal leadthrough providing only the individual thermocouple is to be removed from the metal leadthrough. To this end, the seal via which the thermocouple is connected to the metal leadthrough is to be opened. This seal can for example be removed by means of a suitable mechanical and/or thermal process. Therefore, for example a special cement can be drilled out, or a solder can be liquefied by means of suitable heating so that the relevant thermocouple can be withdrawn from the passage. As a consequence of this, access can therefore be gained directly to individual, possibly defective thermocouples without the metal leadthrough having to be destroyed or also without the additional thermocouples, which are also still inserted in the terminal end region, even having to be removed. This individual exchange of a thermocouple therefore enables the saving of time and material costs, as a result of which for example the downtimes for the working machine can in turn be reduced.

According to an embodiment of the thermocouple system according to the invention, it is provided that the terminal region is at least partially of conical design and in particular the openings of at least two passages on the conically formed outer wall of the terminal region have in the main different distances to the symmetry axis of the cylindrical section. The passages are especially arranged along at least two rings with different diameters around the symmetry axis of the cylindrical section in the terminal region. The individual passages of a ring can in this case be distributed equidistantly over the ring circumference.

According to the embodiment, at least two such rings can therefore be provided so that at least two passages can be defined, the openings of which are at different distances to the symmetry axis. It is therefore not necessary that any openings of the passages have to be at different distances to the symmetry axis in comparison to any other opening. Only two openings need to be able to be defined in such a way that a different spacing exists. According to the embodiment, the effect of the thermocouples which are guided through the respective passages being able to be manipulated at a suitable distance from each other can therefore be achieved. The associated seals especially lie at different height levels on the at least partially conically designed terminal region so that these can be manipulated more easily. Similarly, the effect of the seals of individual thermocouples interacting with each other with excessive force so that when a thermocouple is exchanged the passage which is provided with another thermocouple is also possibly damaged, can therefore be avoided.

According to a further alternative embodiment of the invention, it is provided that the terminal region is at least partially of stepped design so that at least two passages are introduced into different steps of the step-formed terminal region. In particular, these steps in turn circumferentially extend around the symmetry axis of the cylindrical section. Moreover, the passages can be introduced into the terminal region on a step along a ring around the symmetry axis of the cylindrical section. When provision is made for a plurality of steps, a plurality of rings can therefore also be provided. The passages in the individual rings or steps can in turn be distributed equidistantly over the ring. Also, this stepped embodiment of the terminal end region enables in turn improved handling of the individual thermocouples which are guided through individual passages so that the individual passages are in the main mechanically and thermally decoupled from other passages. Also, the stepped embodiment again enables the attachment of the individual thermocouples at different height levels in the region of the terminal end region so that in this case also individual thermocouples can again be advantageously manipulated with a specific aim.

According to a specific embodiment of the invention, it is provided that the seal is a solder which is advantageously a soft solder or a hard solder. If the seal is designed as a soft solder, this can easily be removed again by melting at comparatively low temperatures so that for example the exchange of a thermocouple can be performed without any problem. If a thermocouple

is fastened and sealed by means of a hard solder, then for removing the hard solder a comparatively higher temperature is required, but the hard solder has the advantage of still having adequate resisting power and also fluid tightness and pressure tightness even at higher operating temperatures of the working machine. Depending on the application case, it can be advantageous to select a soft solder or a hard solder for the seal.

According to a further advantageous embodiment of the invention, it is provided that all passages which are not provided with a thermocouple are also sealed in a fluid-tight manner. Such sealing of all the passages is especially necessary for operation in a working machine since otherwise the escape of for example working medium is to be anticipated. If alternatively this disadvantage is not to be anticipated, then a number of passages can also remain unsealed and not closed off, wherein in particular only those passages which are provided with a thermocouple should be sealed.

According to a further embodiment of the invention, it is provided that the opening cross sections of the passages are at least 1.0 mm but at most 7.0 mm in diameter. The diameter in this case is the average diameter of the opening cross section. The opening cross sections in this case refer to the opening cross sections on the outer wall of the terminal region. On account of the small size of the individual passages, which, however, are adequate for the leadthrough of a thermocouple, only a small quantity of special cement or solder is required for sealing the passage after the leading through of the thermocouple. An exchange of the thermocouple is therefore to be accomplished in a comparatively easy manner since only a small quantity of this sealing material is in turn to be removed. Moreover, the individual thermocouples can be easily spaced apart in the terminal end region.

According to a further advantageous embodiment of the invention, it is provided that the passages are designed as holes which extend parallel to the symmetry axis of the cylindrical section. According to this, the holes already establish not only a guide in a predetermined direction but also an insert direction, and therefore an insertion aid when the thermocouple is led through the respective passage. As a result of this, the effect of individual thermocouples coming directly into contact with each other on the side opposite the outer wall of the terminal region after the leading through of these, and therefore possibly causing problems during their leading through, can be avoided.

According to a further embodiment, it is provided that the passages in the longitudinal direction through the material of the terminal region have a length of at least 1.0 mm and at most 10.0 mm. Therefore, adequate material is available in the area of the terminal region for applying the seal in order to fix and also close off the thermocouple in the respective passage in a fluid-tight and pressure-tight manner. At the same time, these thicknesses ensure a problem-free removal of an already applied seal so that the exchange of a thermocouple can be easily performed.

According to an embodiment of the invention, it is provided that tube sections are attached on the outer wall of the terminal region, which tube sections align with the passages and are fixed on said outer wall. These tube sections are especially soldered on. These tube sections constitute not only an advantageous insertion and alignment aid, as already described further above, but, moreover, also constitute an additional surface which is required for applying the sealing material. For applying the seal, these tube sections are in particular to be filled in, wherein these can in turn be easily handled by suitable manipulation, as made clear above, for exchanging the thermocouple.

If the tube section is filled in for example with solder, the solder located therein can liquefy by simple contacting of the tube section with a hot soldering source. By the same token, a tube section can possibly be removed from the terminal end region by directed mechanical forcing so that in this way also removal of the thermocouple from the respective passage can be enabled.

According to a further aspect of the invention, it is provided that the fluid-tight seal between thermocouple and passage is of pressure-tight design up to 30 bar. The person skilled in the art knows in this case which type of seal is to be selected, or can determine by simple trials which pressure-tightness exists in which seal. A pressure-tightness of up to 30 bar allows the thermocouple system to be suitable especially for use in a gas turbine in which for example working pressures of up to 25 bar occur.

The invention shall be described in more detail below with reference to individual figures. In this case, reference is to be made to the fact that the figures are to be understood only schematically and these indicate no limitation with regard to the feasibility.

Reference is furthermore to be made to the fact that all the following technical features are claimed in any combination with each other, providing this combination enables the objects upon which the invention is based to be achieved.

Reference is also to be made to the fact that all technical features which are provided with an identical designation have the same technical function.

### BRIEF DESCRIPTION OF THE DRAWINGS

In this case, in the drawing:

FIG. 1 shows a perspective view from the side of a first embodiment of the thermocouple system according to the invention;

FIG. 2 shows a sectional side view through the embodiment of the thermocouple system shown in FIG. 1;

FIG. 3 shows a further embodiment of the thermocouple system according to the invention in a perspective side view;

FIG. 4 shows a sectional side view through the embodiment of the thermocouple system according to the invention shown in FIG. 3;

FIG. 5 shows a perspective side view of a further embodiment of the thermocouple system according to the invention;

FIG. 6 shows a sectional side view through the embodiment of the thermocouple system according to the invention shown in FIG. 5.

### DETAILED DESCRIPTION OF INVENTION

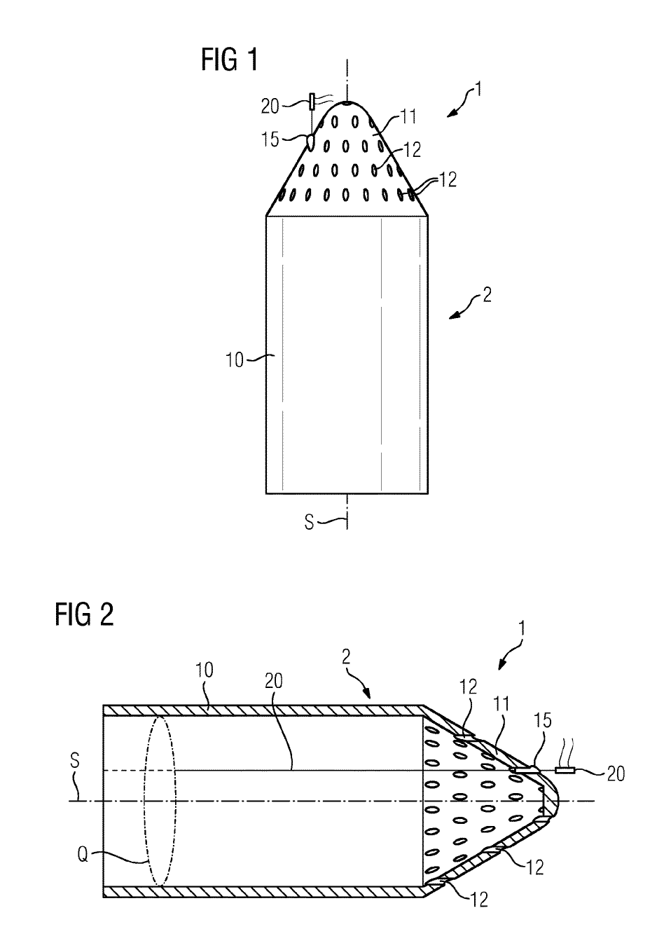

FIG. 1 shows a first embodiment of the thermocouple system 1 according to the invention in a perspective side view, which in addition to a cylindrical section 10 has a terminal end region 11 which in the present case is in the main of conical shape. The terminal end region 11 has a number of passages 12, the opening cross sections of which are distributed over the outer wall of the terminal region 11. Guided through a predetermined passage 12 is a thermocouple 20 which has two electric leads, not additionally provided with designations, which are provided for the contacting. For sealing and for fixing the thermocouple in the respective passage 12 provision is made for a seal 15 which can be designed for example as special cement or as solder. The seal is designed in this case in such a way that the passage along with the thermocouple is sealed in a fluid-tight manner.

It is furthermore to be seen that provision is made for a symmetry axis S of the cylindrical section 10, which represents the rotational symmetry axis. The individual passages 12 in the terminal end region 11 are arranged in this case in a number or rings around this symmetry axis S, wherein the individual rings have a different number of passages 12. The individual passages 12 of a ring in each case are in the main equidistant to the respective adjacent passage 12, wherein advantageously the individual rings are also in the main equidistant to the respectively next adjacent ring.

The thermocouple system 1 can now be guided in its entirety through a suitable opening (not shown in the present case) on an outer casing of a working machine, wherein the cylindrical section 10 of the leadthrough 2 is suitably clamped in the outer casing. In this case, the cylindrical section 10 can for example be inserted into a suitable Swagelok socket and clamped therein. If it were now to be necessary to exchange the thermocouple 20, only the seal 15 would be removed in order to be able to withdraw the thermocouple 20 as a whole from the leadthrough 2. In this respect, the entire leadthrough 2 is no longer to be removed or destroyed but it is sufficient to manipulate just one part, i.e. a specific passage 12.

The embodiment shown in FIG. 1 is shown again in detail in FIG. 2 in a sectional side view. In this, it is be seen that the seal 15 for fixing the thermocouple and for sealing the respective passage fills out the entire passage 12. Also, the other passages, which are not provided with a thermocouple 20, can be sealed against escape and ingress of fluid. It is also to be clearly seen that the opening cross sections of the individual passages are appreciably smaller that the cross-sectional area Q perpendicularly to the symmetry axis S through the cylindrical section 10. If according to the prior art this entire cross-sectional region Q was previously provided with a seal for fixing a thermocouple, then according to the present invention it is now sufficient to provide only a considerably smaller opening region with a seal 15 which consequently can also be removed again more easily.

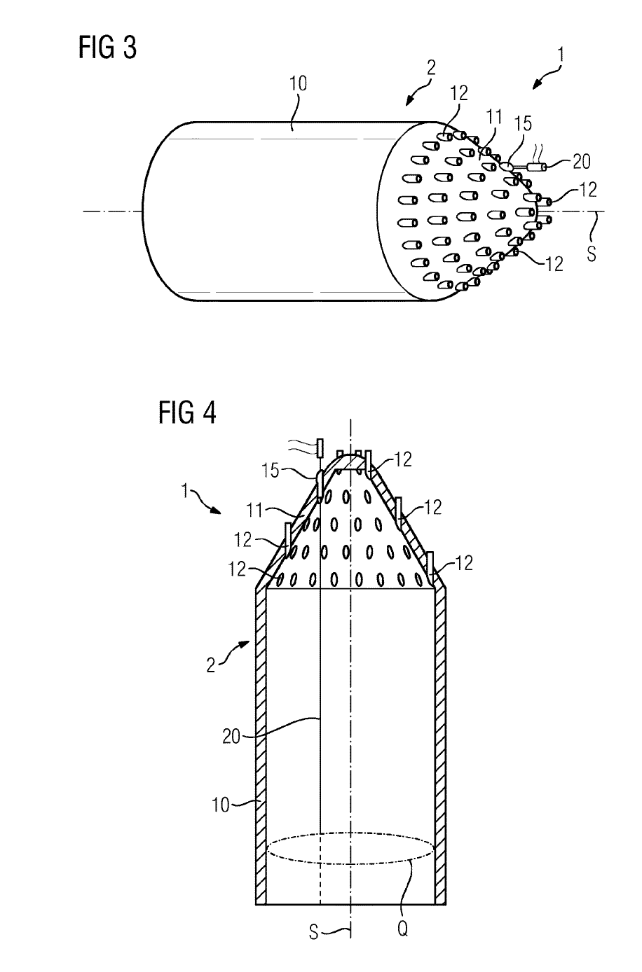

FIG. 3 shows a further embodiment of the thermocouple system 1 according to the invention in a perspective side view. In this case, the embodiment shown in FIG. 3 differs from the embodiment shown in FIGS. 1 and 2 only to the effect that the individual passages 12 in the terminal end region 11 of the leadthrough 2 are provided with small tubes or tube sections. These tubes or tube sections allow an improved guiding of the thermocouple 20 when it is being inserted through the passages 12 as well as an enlarged surface for applying the seal 15 which for example also penetrates into the tube sections. Particularly in the case of soldering the thermocouple 20, the solder can therefore easily be applied to the inner wall of these tube sections and bring about a seal or an attachment for the thermocouple 20.

FIG. 4 shows a sectional side view through the embodiment of the thermocouple system 1 according to the invention shown in FIG. 3, in which again the attachment of the individual tube sections, which are in alignment with the respective passages 12, is shown in more detail.

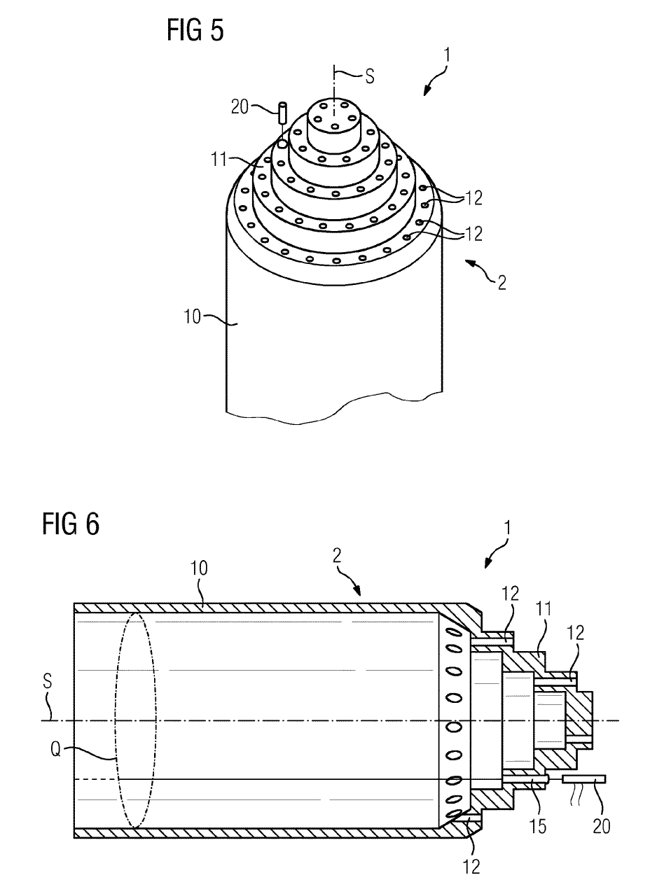

FIG. 5 shows a further embodiment of the thermocouple system 1 according to the invention, wherein in comparison to the previously shown embodiments the terminal end region 11 is now of step-like design. The steps are of circular design and arranged symmetrically to the symmetry axis S. The individual steps are in each case provided with a predetermined number of passages 12, the longitudinal extent of which runs parallel to the orientation of the symmetry axis S. The individual passages 12 of the respective steps have a ring-like arrangement, wherein two adjacent passages 12 in such a ring are in each case equally spaced apart.

FIG. 6 shows a sectional side view through the embodiment of the thermocouple system 1 according to the invention shown in FIG. 5.

Further embodiments are gathered from the dependent claims.

1. A thermocouple system comprising:
a metal leadthrough with a cylindrical section with a symmetry axis and also a terminal end region, arranged thereon, which completely closes off the cylindrical section and has at least two passages, the opening cross section of which is smaller than the cross-sectional area perpendicularly to the symmetry axis through the cylindrical section,
wherein a thermocouple is guided through a passage and in the region of the passage the thermocouple is connected to the terminal region in a fluid-tight manner by means of a seal.

2. The thermocouple system as claimed in claim 1,
wherein the terminal region is at least partially of conical design.

3. The thermocouple system as claimed in claim 1,
wherein the terminal region is at least partially of stepped design and at least two passages are introduced into different steps of the step-formed terminal region.

4. The thermocouple system as claimed in claim 1,
wherein the seal is a solder which is preferably a soft solder or a hard solder.

5. The thermocouple system as claimed in claim 1,
wherein all passages which are not provided with a thermocouple are also sealed in a fluid-tight manner.

6. The thermocouple system as claimed in claim 1,
wherein the opening cross sections of the passages are at least 1.0 mm but at most 7.0 mm in diameter.

7. The thermocouple system as claimed in claim 1,
wherein the passages are designed as holes which extend parallel to the symmetry axis of the cylindrical section.

8. The thermocouple system as claimed in claim 1,
wherein the passages in the longitudinal direction through the material of the terminal region have a length of at least 1.0 mm and at most 10.0 mm.

9. The thermocouple system as claimed in claim 1,
wherein tube sections are attached on the outer wall of the terminal region, which tube sections are in alignment with the passages and are fixed on the outer wall.

10. The thermocouple system as claimed in claim 1,
wherein the fluid-tight seal between thermocouple and passage is of pressure-tight design up to 30 bar.

11. A gas turbine comprising:
at least one thermocouple system as claimed in claim 1,
wherein the thermocouple system is integrated into the outer casing of the gas turbine.

12. The thermocouple system as claimed in claim 2,
wherein the openings of at least two passages on the conically formed outer wall of the terminal region have in the main different distances to the symmetry axis of the cylindrical section.

13. The thermocouple system as claimed in claim 4,
wherein the seal is a soft solder or a hard solder.
